(19) United States
(12) Patent Application Publication
(10) Pub. No.: US 2013/0041993 A1
(43) Pub. Date: Feb. 14, 2013

(54) SYSTEM AND METHOD FOR PROVIDING WEB SERVICE FOR SMART OBJECTS

(71) Applicants: Jong Soo JEONG, Daejeon (KR); Hae Yong KIM, Daejeon (KR); Sang Cheol Kim, Gyeongbuk (KR); Seon Tae Kim, Daejeon (KR); Gyu Sang Shin, Daejeon (KR)

(72) Inventors: Jong Soo JEONG, Daejeon (KR); Hae Yong KIM, Daejeon (KR); Sang Cheol Kim, Gyeongbuk (KR); Seon Tae Kim, Daejeon (KR); Gyu Sang Shin, Daejeon (KR)

(73) Assignee: ELECTRONICS AND TELECOMMUNICATIONS RESEARCH INSTITUTE, Daejeon (KR)

(21) Appl. No.: 13/571,866

(22) Filed: Aug. 10, 2012

(30) Foreign Application Priority Data
Aug. 10, 2011 (KR) 10-2011-0079596

(51) Int. Cl. G06F 15/173

(52) U.S. Cl. 709/223

(57) ABSTRACT

A system and method for providing web service for smart objects are provided. The system includes a smart object and a repeater. The smart object receives a web service request for the smart object from a service-requesting user, and transmits a message including information on a web server associated with the web service request to a repeater. The repeater receives the message including the information on the web server associated with the web service request from the smart object, transfers the web service request to the web server and, when a response for the request is received from the web server, transfers the response to the service-requesting user. Accordingly, the present invention can provide a web service to independent of n insufficient memory capacity of a smart object and a limited network.

### CLAIM FOR PRIORITY

This application claims priority to Korean Patent Application No. 10-2011-0079596 filed on Aug. 10, 2011 in the Korean Intellectual Property Office (KIPO), the entire contents of which are hereby incorporated by reference.

### BACKGROUND

1. Technical Field

Example embodiments of the present invention relate in general to a method and system for providing web service for smart objects, and more specifically to a method and system for quickly providing a web service for smart objects requiring many computers and communication resources without restriction of resources.

2. Related Art

Advancements in sensor technology based on micro electro mechanical systems (MEMS), operating system technology for ultra-small embedded apparatuses based on a 8/16-bit microprocessor, and low-power wireless communication technology such as IEEE 802.15.4 have led to advancements in smart objects and wireless sensor network technology. The technology is expected to be applied to a wireless control system for industry, environment monitoring, and smart grid. However, due to a communication scheme and an address system that differ from those of existing web-based IT systems, there is difficulty in combining the technology with the existing systems. To overcome these limitations and successfully commercialize the technology, an operational connection with the existing well-advanced Internet and web is required. For this reason, a concept known as the Internet of things has been proposed. The Internet of things is technology that applies the IPv6 network function to smart objects and thus enables access of the smart objects on the web.

By using such technology, various objects autonomously configure the IPv6 network, and by providing users with a web application program interface (API) suitable for characteristics of each of the objects, a greater variety of application services can be provided.

Smart objects include white goods and various sensors and actuators, which have very restricted resources, unlike general computers. Generally, since smart objects use a 8/16-bit microprocessor, processing performance is low, and the capacities of random access memories (RAMs) and flash memories are limited. Sometimes, a device that is driven with a battery is required, and the bandwidth of a communication link is limited.

In such an environment, it is not suitable to implement a text-based application layer such as hypertext transfer protocol (HTTP), and thus, the Internet Engineering Task Force (IETF) constrained RESTful environment (CoRE) architecture is discussed. The architecture uses CoAP over UDP that is light and provides a certain level of reliability, instead of heavy HTTP over TCP. In such an architecture, each smart object acts as an ultra-small web server.

A user can directly access a specific smart object through a web browser, for checking and controlling the state of the specific smart object. General web pages represented on web browsers are configured with hypertext markup language (HTML), JavaScript, cascading style sheets, and image files. General web servers have no large difficulty in providing services for the web pages. However, smart objects have a limited memory capacity and a limited communication bandwidth, and thus, in performing a check through a smart objects, it is difficult to perform transmission for providing a service for smart objects to a user.

### SUMMARY

Accordingly, example embodiments of the present invention are provided to substantially obviate one or more problems due to limitations and disadvantages of the related art.

Example embodiments of the present invention provide a system for providing a web service for smart objects independent of the limited processing performance, memory capacity, and communication bandwidth of each of the smart objects.

Example embodiments of the present invention also provide a method of providing a web service for smart objects independent of the limited processing performance, memory capacity, and communication bandwidth of each of the smart objects.

In some example embodiments, a system for providing a web service for smart to objects includes: a smart object configured to receive a web service request for the smart object from a service-requesting user, and transmit a message including information on a web server associated with the web service request to a repeater; and a repeater configured to receive the message including the information on the web server associated with the web service request from the smart object, transfer the web service request to the web server and, when a response for the request is received from the web server, transfer the response to the service-requesting user.

The information on the web server may include a URL of the web server, and may be stored in a memory of the smart object. The web server may store a web page resource corresponding to the smart object, and when the web service request is received, the web server may provide the web page resource in response to the request. The repeater may be a proxy.

In other example embodiments, a method of providing a web service for a smart object, which is performed by the smart object connected to a repeater over a network, includes: receiving a web service request for the smart object from a service-requesting user; and transmitting a message including information on a web server associated with the web service request to a repeater such that the web service request is transferred to the web server through the repeater.

The information on the web server may include a URL of the web server, and may be stored in an internal memory of the smart object or an external memory.

A response to the web service request may be transferred from the web server to the service-requesting user through the repeater.

The web server may store a web page resource for the smart object, and when the web service request is received, the web server may provide the web page resource in response to the request.

The repeater may be a proxy. to The smart object may be an object in which an information processing function and an information exchange function are added to a unique function of an object by embedding at least one of a sensor, a driver, a communication transceiver, and a processor in a generally used object.

In still other example embodiments, a method of providing a web service for at least one smart object, which is performed by a repeater connected to the at least one smart object over a network, includes: receiving a message including information on a web server associated with the web service request from a smart object which has received a web service request from a service-requesting user; transferring the web service request to the web server by using the information on the web server; receiving a response to the web service request transferred to the web server, from the web server; and transferring the received response to the service-requesting user.

The web server may store a web page resource for the smart object, and when the web service request is received, the web server may provide the web page resource in response to the request.

The repeater may be a proxy.

### BRIEF DESCRIPTION OF DRAWINGS

The above and other objectives, features and advantages the present invention will become more apparent by describing in detail example embodiments of the present invention with reference to the accompanying drawings, in which:

FIG. 1 is a conceptual diagram schematically illustrating a system for providing web service for smart objects according to an embodiment of the present invention;

FIG. 2 is a conceptual diagram illustrating a flow of a message for providing web service for smart objects according to an embodiment of the present invention;

FIG. 3 is a sequence chart illustrating an operation for providing web service for smart to objects according to an embodiment of the present invention, in terms of a smart object;

FIG. 4 is a sequence chart illustrating an operation for providing web service for smart objects according to an embodiment of the present invention, performed by a repeater; and

FIG. 5 is a sequence chart illustrating an operation for providing web service for smart objects according to an embodiment of the present invention, performed by a web server.

### DESCRIPTION OF EXAMPLE EMBODIMENTS

The invention may have diverse modified embodiments, and thus, example embodiments are illustrated in the drawings and are described in the detailed description of the invention. However, this does not limit the invention within specific embodiments and it should be understood that the invention covers all the modifications, equivalents, and replacements within the idea and technical scope of the invention. Like numbers refer to like elements throughout the description of the figures.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus to “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the present invention will be described in detail with reference to the accompanying drawings.

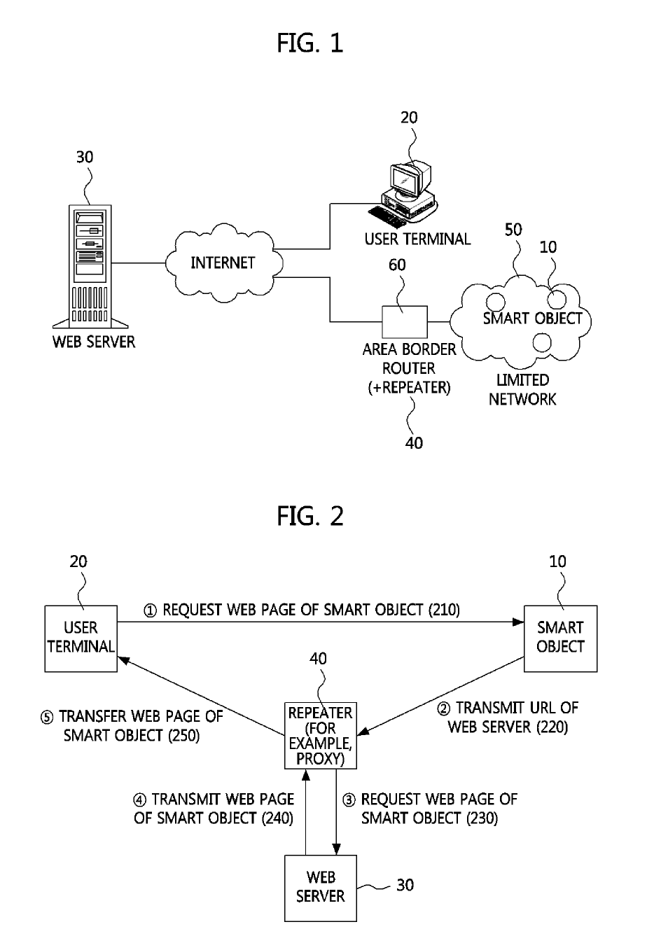

FIG. 1 is a conceptual diagram schematically illustrating a system for providing web service for smart objects according to an embodiment of the present invention.

Referring to FIG. 1, the system for providing web service for smart objects according to an embodiment of the present invention includes a plurality of smart objects 10, a user terminal 20, a web server 30, and a repeater 40.

First, the schematic configuration of the system for providing web service for smart objects according to an embodiment of the present invention will be described with reference to FIG. 1.

Referring to FIG. 1, the smart objects 10 according to an embodiment of the present invention may be connected to a limited communication link (for example, IEEE 802.15.4, PLC, etc.). The IPv6 network that is configured in this way is called a limited network 50. The network 50 is connected to an external network through an area border router 60. A user may receive a web service from the smart objects 10 through a web browser of the user terminal 20.

In an embodiment of the present invention, the repeater 40 is used as a device that relays a service request and response between the smart objects 10 and the web server 30. A proxy may be used as the repeater 40. The repeater 40 performs a reverse proxy function of providing normal web contents of the smart objects 10 that are originally disposed in the limited network 50, instead of the smart objects 10. The repeater 40 may be integrated with the area border router 60 or installed as a separate device.

Moreover, a smart object manufacturer provides the web server 30 that provides web page resources according to the kinds of smart objects. The repeater 40 and the web server 30 may be used for overcoming a limited communication bandwidth and a limited memory capacity of the smart objects 10.

Next, the more detailed function of each element of the system for providing web service for smart objects according to an embodiment of the present invention will be described with reference to FIG. 1.

A smart object 10 receives a web service request for a smart object from a user through the user terminal 20, and sends a message, including information on a web server associated with the received web service request, to the repeater 40. The smart object 10 denotes an object in which an information processing function and an information exchange function are added to the unique function of an object by embedding a wired/wireless communication transceiver, a sensor, a driver, and a processor in a generally used object.

In this case, the information on the web server may include an URL of the web server. Also, the information may be stored in a memory of a smart object. The repeater 40 receives a message that includes information on the web server 30 associated with a web service request from the smart object 10, transfers the web service request to the web server 30, receives a response for the request from the web server 30, and transfers the response to the user terminal 20 (i.e., a service-requesting user), thereby performing a relay function. The repeater 40 that performs the relay function is not limited to a proxy.

The web server 30 receives the web service request from the repeater 40, and transmits the response to the web service request to the repeater 40. The web server 30 stores web page resources respectively corresponding to smart objects, and when the web server 30 receives the web service request, the web server 30 may provide a web page resource for the smart object 10 in response to the request.

FIG. 2 is a conceptual diagram illustrating a flow of a message for providing web service for smart objects according to an embodiment of the present invention.

Referring to FIG. 2, the message for providing web service for smart objects according to an embodiment of the present invention may include request 210 of a web page of a smart object, transmission 220 of a manufacturer web server URL, transfer 230 of the smart object's web page request, transmission 240 of the web page of the smart object, and transfer 250 of the web page of the smart object.

That is, when the user 20 inputs a URL of the smart object 10 for accessing to an address window of a web browser for accessing the smart object 10, a web page request message 210 is sent to a corresponding smart object 10 through the web browser, in operation 210.

When the corresponding smart object 10 receives the message 210, the corresponding smart object 10 adds a URL, indicating a web server (for example, a web server that is provided by a smart object manufacturer) corresponding to the kind of the corresponding smart object 10, into a message 220 and sends the message 220 with the URL added therein to the repeater 40, in operation 220.

The repeater 40 receiving the message 220 transfers the web page request message 210 of the smart object 10 to a URL of the manufacturer included in the message 210, and thus requests the web page of the corresponding smart object 10, in operation 230.

In response to the request, the manufacturer web server 30 transmits the web page of the corresponding smart object 10, in operation 240. The repeater 40 transfers the web page received from the web server 20 to an initially requesting user, instead of the smart object 10, in operation 250.

Such an operation may be performed with a plurality of application protocol messages according to HTTP or CoAP. Also, to more smoothly perform the operations, a web page resource of an object manufactured by a smart object manufacturer may be provided through a web server, and a smart object may be manufactured such that a URL of a corresponding web server is stored in a flash memory.

Generally, URLs have a size of less than several bytes to tens of bytes, and thus, storing a URL in a flash memory is more efficient than storing all web page resources of a smart object in a memory of the smart object.

In the above-described operation, a communication link (IEEE 802.15.4, power line communication, etc.) for a communication section between the user terminal 20 and the smart object 10 and a communication section between the smart object 10 and the repeater 40 is a limited communication link, and a communication link for all the other communication sections is a wideband link. Web page resources having a large size are transmitted through the wideband link, and only light messages of several bytes to tens of bytes are exchanged through the limited communication link, thus preventing various drawbacks that are caused when transmitting a web page having a large size through the limited communication link. Particularly, in smart objects that are driven with a battery, the number of communications is reduced by the above-described method, thus extending the service life of batteries.

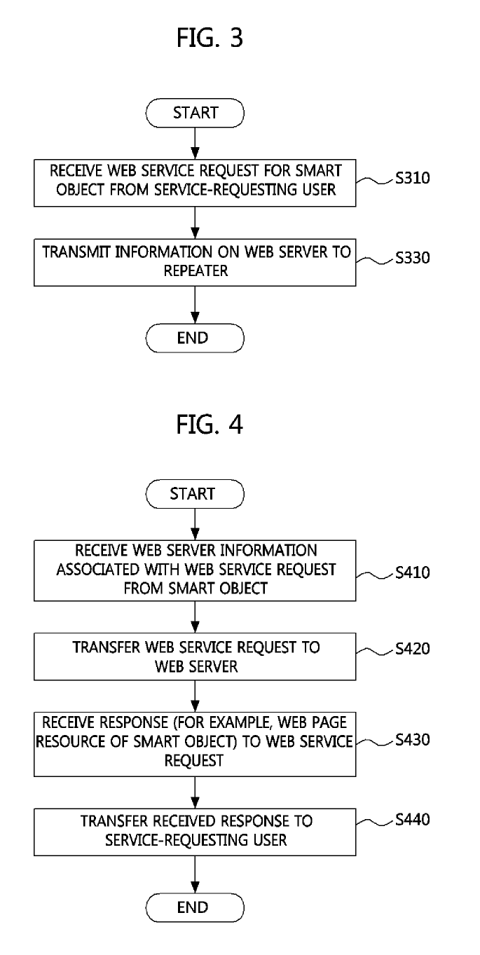

FIG. 3 is a sequence chart illustrating an operation for providing web service for smart objects according to an embodiment of the present invention, in terms of a smart object.

Referring to FIG. 3, the operation for providing web service for smart objects according to an embodiment of the present invention that is performed by a smart object includes stage S310 of receiving a web service request, and stage S330 of transmitting web server information to a repeater.

Moreover, referring to FIG. 3, a smart object according to an embodiment of the present invention is connected to a repeater over a network, requests a web service through the repeater, and enables a service-requesting user to receive a service through the repeater. The stages of the operation for providing web service for smart objects will be described as follows.

Stage S310 of receiving the web service request is a stage in which a user, namely, a service-requesting user requests a web service for a smart object, and for example, a stage of receiving a request for a web page of the smart object.

Stage S330 of transmitting the web server information to the repeater is a stage of sending a message including information on a web server of the smart object to the repeater, and thus allows the web service request to be transferred to the web server through the repeater.

Moreover, the web server may store a web page resource for the smart object, and when the web server receives the web service request, the web server may provide the web page resource in response to the request. The web page resource that is provided in this way may be transferred to the service-requesting user through the repeater.

FIG. 4 is a sequence chart illustrating an operation for providing web service for smart objects according to an embodiment of the present invention, performed by a repeater.

Referring to FIG. 4, the operation for providing web service for smart objects according to an embodiment of the present invention that is performed by a repeater includes stage S410 of receiving web server information from a smart object, stage S420 of requesting a web service, stage S430 of receiving a response to the web service request, and stage S440 of transferring the response.

Moreover, referring to FIG. 4, the stages of the operation for providing web service for smart objects according to an embodiment of the present invention that is performed by the repeater will be described as follows.

Stage S410 of receiving the web server information is a stage of receiving a message, which includes information on a web server associated with the web service request, from a smart object that has received the web service request from a service-requesting user.

Stage S420 of requesting the web service is a stage of transferring the web service request to the web server by using web server URL information which is included in the information on the web server transmitted from the smart object.

Stage S430 of receiving the response to the web service request is a stage that again receives the response to the web service request, which has been transferred to the web server, from the web server. Especially, the web server stores a web page resource for the smart object, and thus provides the web page resource in response to the request.

Stage S440 of transferring the response is a stage of transferring the response, received from the web server, to the service-requesting user.

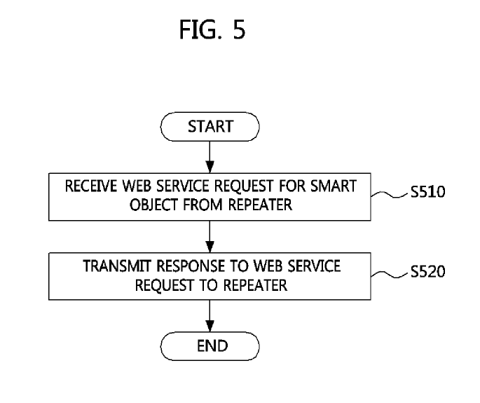

FIG. 5 is a sequence chart illustrating an operation for providing web service for smart objects according to an embodiment of the present invention, performed by a web server.

Referring to FIG. 5, the operation for providing web service for smart objects according to an embodiment of the present invention that is performed by a web server includes stage S510 of receiving a web service request from a repeater, and stage S520 of transmitting a response to the web service request.

Moreover, referring to FIG. 5, the stages of the operation for providing web service for smart objects according to an embodiment of the present invention that is performed by the web server will be described as follows.

Stage S510 of receiving the web service request from the repeater is a stage of receiving a corresponding request from the repeater which has received the web service request from a smart object. That is, the web server according to an embodiment of the present invention is connected to the repeater connected to the smart object over a network, and receives the web service request for the smart object through the repeater.

Stage S520 of transmitting the response to the web service request is a stage of transmitting the response to the web service request, which has been received through the repeater, to the repeater. The transmitted response may be transferred to a service-requesting user through the repeater. The web server may transmit a web page resource corresponding to the smart object in response to the request.

In the above-described system and method for providing web service for smart objects according to the present invention, a web service request for a smart object is transferred to the web server through the repeater (for example, proxy), and the web server stores a web page of the smart object. When the web server receives the service request, the web server transfers the web page of the smart object to a service-requesting user, thus providing a web service independent of the insufficient memory capacity of the smart object and a limited network.

Accordingly, the present invention provides a web application and a sufficient web service requiring high processing performance, a large memory capacity, and a large bandwidth to users irrespective of the limited resources of smart objects. Users can obtain a higher level of user experience when receiving a web service from a smart object through a web browser. When a smart object manufacturer desires to update a web page of a specific smart object, the smart object manufacturer needs to perform an operation of updating the existing web pages stored in respective memories of previously installed smart objects to new web pages. However, when posting a new web page on the web server, the web service to providing method according to the present invention provides the new web page instead of a smart object to users through proxies of target objects for updating, and thus can more quickly provide a newly updated web service to users.

While the example embodiments of the present invention and their advantages have been described in detail, it should be understood that various changes, substitutions and alterations may be made herein without departing from the scope of the invention.

What is claimed is:

1. A system for providing a web service for smart objects, the system comprising:
a smart object configured to receive a web service request for the smart object from a service-requesting user, and transmit a message comprising information on a web server associated with the web service request to a repeater; and
a repeater configured to receive the message comprising the information on the web server associated with the web service request from the smart object, transfer the web service request to the web server and, when a response for the request is received from the web server, transfer the response to the service-requesting user.

2. The system of claim 1, wherein,
the information on the web server comprises a URL of the web server, and is stored in a memory of the smart object,
the web server stores a web page resource corresponding to the smart object, and when the web service request is received, the web server provides the web page resource in response to the request, and
the repeater is a proxy.

3. A method of providing a web service for a smart object which is performed by the smart object connected to a repeater over a network, the method comprising:
receiving a web service request for the smart object from a service-requesting user; and
transmitting a message comprising information on a web server associated with the web service request to the repeater such that the web service request is transferred to the web server through the repeater.

4. The method of claim 3, wherein the information on the web server comprises a URL of the web server, and is stored in an internal memory of the smart object or an external memory.

5. The system of claim 3, wherein a response to the web service request is transferred from the web server to the service-requesting user through the repeater.

6. The method of claim 3, wherein the web server stores a web page resource for the smart object, and when the web service request is received, the web server provides the web page resource in response to the request.

7. The method of claim 3, wherein the repeater is a proxy.

8. The method of claim 3, wherein the smart object is an object in which an information processing function and an information exchange function are added to a unique function of an object by embedding at least one of a sensor, a driver, a communication transceiver, and a processor in a generally used object.

9. A method of providing a web service for at least one smart object which is performed by a repeater connected to the at least one smart object over a network, the method comprising:
receiving a message comprising information on a web server associated with the web service request from a smart object which has received a web service request from a service-requesting user;
transferring the web service request to the web server by using the information on the web server;
receiving a response to the web service request transferred to the web server, from the web server; and
transferring the received response to the service-requesting user.

10. The method of claim 9, wherein the web server stores a web page resource for the smart object, and when the web service request is received, the web server provides the web page resource in response to the request.

11. The method of claim 9, wherein the repeater is a proxy.

12. The method of claim 4, wherein the repeater is a proxy.

13. The method of claim 5, wherein the repeater is a proxy.

14. The method of claim 6, wherein the repeater is a proxy.

15. The method of claim 4, wherein the smart object is an object in which an information processing function and an information exchange function are added to a unique function of an object by embedding at least one of a sensor, a driver, a communication transceiver, and a processor in a generally used object.

16. The method of claim 5, wherein the smart object is an object in which an information processing function and an information exchange function are added to a unique function of an object by embedding at least one of a sensor, a driver, a communication transceiver, and a processor in a generally used object.

17. The method of claim 6, wherein the smart object is an object in which an information processing function and an information exchange function are added to a unique function of an object by embedding at least one of a sensor, a driver, a communication transceiver, and a processor in a generally used object.

18. The method of claim 10, wherein the repeater is a proxy.
